(19) United States
(12) Patent Application Publication
(10) Pub. No.: US 2004/0183670 A1
(43) Pub. Date: Sep. 23, 2004

(54) Remote sensor system

(76) Inventor: Frank Ferrara, NSW (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/479,338

(22) PCT Filed: Jun. 3, 2002
(86) PCT No.: PCT/AU02/00705

(30) Foreign Application Priority Data
Jun. 1, 2001 (AU) PR 5421

(51) Int. Cl. G08B 1/08

(52) U.S. Cl. 340/539.1

(57) ABSTRACT

A security alarm wireless energy saving system that allows for the saving of electrical energy by incorporating a miniature coded 0111′ radio transmitter (37) into new or existing security alarm detection devices (35).

The present invention relates to a remote sensor system and, more particularly, to such a system suited for use, although not exclusively, in relation to security systems or component parts thereof.

### BACKGROUND

All over the world, there are millions of security alarm systems installed that use various methods of detecting an intruder, most commonly by sensing motion or the opening/closing of a door. The detection devices used in these security systems are always active, even when the actual alarm system is not armed. Unless the alarm system is actually armed, the alarm control panel ignores the signals it continually receives from the detection devices This is a great waste of the detection device, as it could be used to control other electrical devices such as lighting when movement in an area is detected or a door is opened. There have been many proposals that relate to using alarm sensors to control other electrical devices, but these have all relied on either the system being originally installed with energy saving in mind, or by having to have extensive cabling and electrical work done later on. If wireless technology is utilized, then the existing alarm detection devices have to be replaced with both new wireless detection devices and matching receivers made by the one manufacturer. These proposals have the disadvantage that either expensive and sometimes impossible building cabling needs to be carried out, or that costly additional detection devices need to be installed that require additional energy, negating some of the desired outcomes of reducing energy consumption.

It is an object of the present invention to address or ameliorate one or more of the above mentioned disadvantages, or at least provide a useful alternative.

### BRIEF DESCRIPTION OF INVENTION

Accordingly, in one broad form of the invention there is is provided a security alarm wireless energy saving system that allows for the saving of electrical energy by incorporating a miniature coded UHF radio transmitter into new or existing security alarm detection devices.

Preferably said transmitter communicates with a matching coded UHF receiver.

Preferably said transmitter design can be adopted by alarm system manufacturers to be incorporated into the circuitry of their existing or future alarm detection device designs.

Preferably said receiver design can be adopted by alarm system or electrical appliance manufacturers to be incorporated into the circuitry of their existing or future products.

In yet a further broad form of the invention there is provided an alarm detection device incorporating a radio transmitter for transmission of a predetermined condition of said alarm detection device.

Preferably said alarm detection device comprises a movement detector for a room and said predetermined condition is the condition of detection of movement in said room by said movement detector.

Preferably said radio transmitter is integral to said alarm detection device.

Preferably said radio transmitter is adapted to be retrofitted to said alarm detection device.

Preferably said alarm detection device is powered by a battery.

Preferably said radio transmitter is adapted for communication with a receiver mounted in a light switch.

Preferably said light switch includes a receiver means and switch means for selectively interrupting power to a room light mounted in said room.

Preferably said switch means is integral to said light switch.

Preferably said receiver and switch means is adapted to be retrofitted to said switch.

Preferably said receiver and switch means is powered by the same power supply which powers said light.

Preferably said receiver and switch means is powered by leakage current from said light circuit

In yet a further broad form of the invention there is provided a switch module for retrofitting to a light switch; said switch module incorporating receiver means and switch means; said receiver means adapted to receive a signal from the radio transmitter of an alarm detection device according to any one of claims 5 to 15.

Preferably said switch means is adapted to interrupt power supply between said switch module and an appliance powered by said switch module.

In yet a further broad form or the invention there is provided a transmission module for retrofitting to an alarm detection device; said transmission module including a radio transmitter for transmission of a predetermined condition of said alarm detection device.

Preferably said device comprises a movement sensor.

Preferably maid alarm detection device comprises a trip switch or door or window position switch.

Preferably said detection device is in communication with said existing security alarm detection device.

In yet a further broad form of the invention there is provided a security alarm wireless energy saving system including at least one alarm detection device in combination with at least one integral switch receiver; said system allowing for the saving of electrical energy by incorporating a miniature coded UHF radio transmitter into a new or existing security alarm (sensor) detection device; and wherein said radio transmitter is adapted inside the sensor for communication with said integral receiver switch: and wherein said receiver switch incorporates the means for selectively interrupting power to a room light mounted in the same room as at least one alarm detection device; and wherein said switch means is integral to said light switch; and wherein said receiver and switch means is powered by series current load.

In yet a further broad form of the invention there is provided a pilot transmitter system for transmission of RF radio signals to a light-switch based receiver mounted at close range.

Preferably information is transmitted in bursts only.

Preferably range is between 1 m and 400 m.

More preferably range is between 1 m and 200 m.

Yet more preferably range is between 1 m and 50 m.

Yet more preferably range is within a single room.

In yet a further broad form of the invention there is provided a system for deriving leakage current from a two wire system, said system comprising utilising only predetermined portions of said leakage current.

Preferably said leakage current takes a sinusoidal wave form and said predetermined energy comprises a portion of energy at or close to zero crossings of said wave form.

In yet a further broad form of the invention there is provided a method for minimising lighting energy usage in conjunction with the operation of an alarm motion detector; said method comprising:

(a) installing wireless activated switching means as or as a substitute for on existing light switch for a room;

(b) installing or activating a motion detector transmitter located in an alarm motion detector mounted in said room;

whereby said transmitter can transmit to said wireless activated switching means a “motion sensed” signal; said “motion sensed” signal causing said wireless activated switching means to supply power to a light in said room.

Preferably said wireless activated switching means includes daylight sensing means whereby power is supplied to said light when daylight is not sensed.

Preferably said alarm motion detector is also in communication with an alarm system whereby a “motion sensed” signal is also communicated via said motion detector transmitter to an alarm system located independently of said light switch.

Preferably said alarm motion detector is located so as to function as a motion detector for detection of motion occurring anywhere in said room.

In yet a further broad form of the invention there is provided a system for minimizing lighting energy usage for use in conjunction with an alarm system comprising installing wireless activated switching means as a substitute for an existing light switch in a room; installing or activating a motion detector transmitter located in an alarm motion detector mounted in said room; said alarm motion detector utilised for transmitting a “motion sensed” signal both to said wireless activated switching means and also to an alarm system.

### BRIEF DESCRIPTION OF DRAWINGS

Embodiments of the present invention will now be described with reference to the accompanying drawings wherein:

FIG. 1 illustrates a movement sensor incorporating a transmitter in accordance with a first embodiment of the present invention;

FIG. 2 illustrates a movement sensor having a retrofitted transmitter in accordance with a second embodiment of the present invention;

FIG. 3 illustrates a movement sensor incorporating a battery powered embodiment of the present invention;

FIG. 4 illustrates a remotely operated device in the form of a light switch in accordance with a further embodiment of the present invention;

FIG. 5 illustrates application of an embodiment of the present invention to a conventional room and room light;

FIG. 5 illustrates detail of wiring interconnection for a second preferred embodiment of the present invention;

FIG. 7 illustrates switching positions for the embodiment of FIG. 6;

FIG. 8 is a wiring diagram suitable for wiring the system of the second embodiment;

FIG. 9 is an alternative wiring diagram suitable for wiring the system of the second embodiment;

FIG. 10 is a schematic diagram of an electronic circuit suitable for implementing the system of the second embodiment;

FIG. 11A illustrates a typical mains frequency AC voltage way form;

FIG. 11B illustrates those portions or the way form of FIG. 11A utilised by the system of the second embodiment;

FIG. 11C illustrates those portions of the way form of FIG. 11A typically used by prior art systems;

FIG. 12 is a perspective, underside view of a transmitter unit suitable for use with the system of either the first or second embodiment thereby to provide a system according to a third embodiment;

FIG. 13 is a perspective, top view of a transmitter unit in accordance with the third embodiment;

FIG. 14 is a circuit diagram of the transmitter unit according to the third embodiment.

### DETAILED DESCRIPTION OF PREFERRED EMBODIMENTS

### First Embodiment

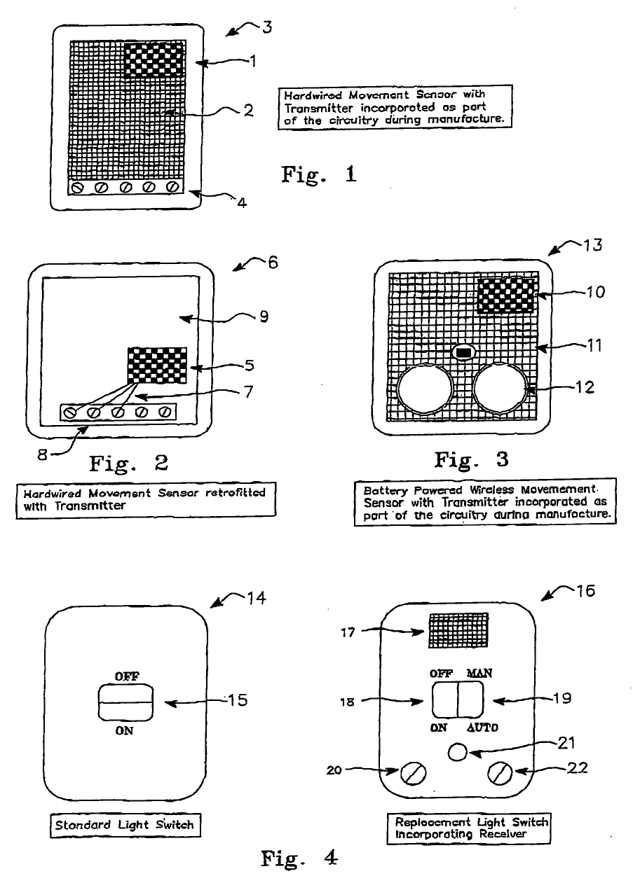

Referring to FIG. 1 it can be seen that the electronic circuitry of the transmitter 1 bas been incorporated as part of the main circuit board 2 of an alarm detection device 3. The detection device circuitry will trigger the standard wired outputs connected to an alarm system 4 as well as the transmitter 1. The coded UHF radio signal sent from the transmitter 1 will be received by a matching coded receiver (FIG. 4, 17).

FIG. 2 shows where a transmitter 5 has been retrofitted to an existing alarm detection device 6 connected by wires 7 that source power and a trigger signal from the terminals on the detection device 5. The transmitter circuitry 5 is separate from the main detection device circuitry.

Referring to FIG. 3 it can be seen that the electronic circuitry for the transmitter 10 has been incorporated as part of the main circuit board 11 of a wireless battery powered 12 alarm detection device 13. The detection device circuitry will trigger the transmitter 10. The coded UHF radio signal sent from the transmitter will be received by a matching coded receiver (FIG. 4, 17).

FIG. 4 shows an existing switch panel for an electrical device, such as a light switch 14 that has an on or off position 15. This original switch panel 14 is replaced by a new switch panel 16 that incorporates and conceals a receiver 17. By using the regular switch 18 the light can be turned on or off as per the original switch 15, provided that the second switch 19 is in the Manual (Off) position. If the Auto position is selected on the second switch 19, the receiver 17 will wait for a valid code from a transmitter 1, 5 or 10 and will then turn the light on for a set period determined by the timing adjustment circuit 20. Further to this function, the new switch panel 16 may also incorporate a daylight sensor 21 that will prevent the lights from being switched on unnecessarily if the area is already adequately illuminated. The daylight sensor has a lighting level adjustment circuit 22 to set what lighting level is required before the lights will be switched on.

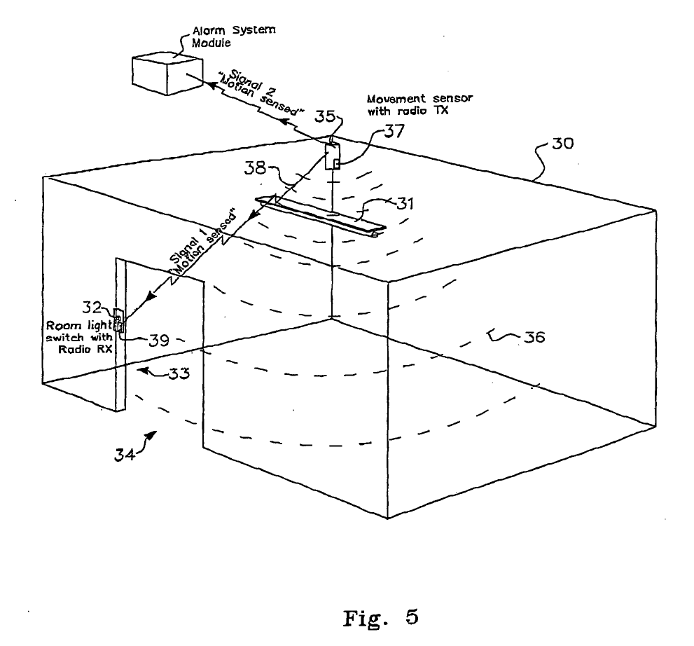

A particular preferred form of the present invention will now be illustrated with reference to FIG. 5.

FIG. 5 illustrates a room 30 illuminated by ceiling light 31, the light 31 in normal circumstances being operated by room light switch 32 mounted against a door jamb 33 of a door entry 34 to room 30.

In this instance the room 30 has a movement sensor 35 installed in at least one top corner thereof, as illustrated in FIG. 5 In this instance the movement sensor 35 is of either the infrared or ultrasonic type or microwave radar or digital video pixel sensing ad adapted to detect interruption of its infrared or ultrasonic beam 36 in the event a person, for example, moves into room 30. In this instance sensor 35 includes a radio transmitter 37 therein. The radio transmitter is adapted to detect a predetermined condition of movement sensor 35 and the to transmit that predetermined condition as a coded signal 38 to a receiver 39 installed in and as part of light switch 32.

In this instance the predetermined condition for sensor 35 is the condition at which it senses the presence of a person within room 30. This predetermined condition, when communicated to light switch 32 via receiver 39 causes receiver 39 to bypass the operation of light switch 32 to the extent that light 31 will be turned on irrespective of the manual position of room light switch 32.

A predetermined time after movement is no longer detected in room 36 by sensor 35 the predetermined condition is deemed by sensor 35 to no longer exist and, as a result, signal 38 no longer signals room light switch 32 to be turned to the on position.

### EXAMPLE 1

One particular form of transmitter will now be described by way or example and including a full technical specification thereof.

System Operation:

The system can be configured to Auto or Manual and turned on or off by the user. If Auto is selected the light will automatically turn itself on when the client triggers the associated peripheral device such as a wireless reed witch (WREED) and will turn off when the preset time has been reached from when the device was last triggered. If the manual operation is selected then the user can turn the light on and off manually just as a normal light works.

The user can also turn the light on even it the light is in automatic mode so chat it will not automatically turn off.

Power Supply:

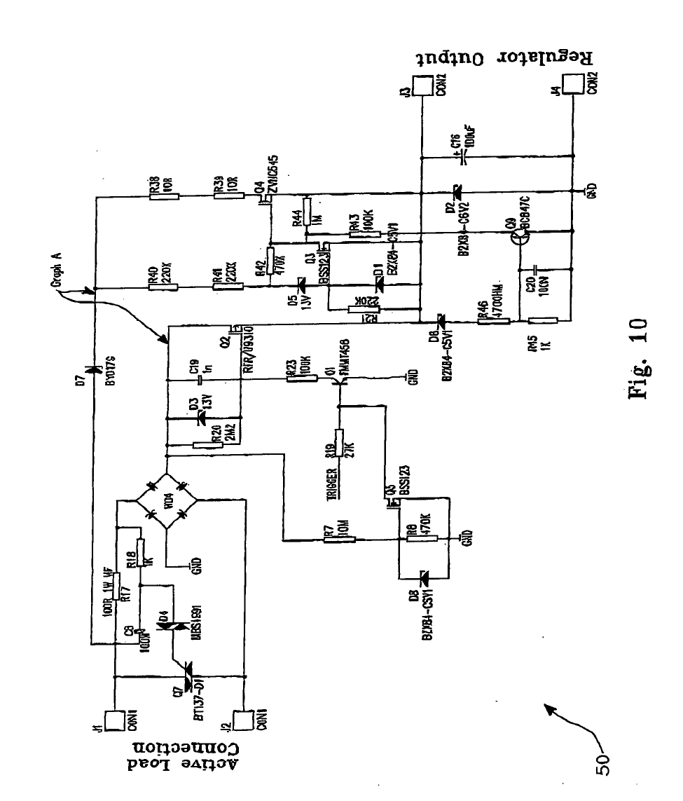

This is the technical explanation of the circuit operation with reference to FIG. 10.

The load may comprise of a Coil connected to neutral (i.e. an electric motor, light globe or transformer).

When the triac is in the off state supply to the digital circuit is produced by rectifying the voltage dropped across the 68n (C15) Capacitor.

In the none triggered state (Light on) the digital circuit has its current supplied via the 33K 2W resistor (R21). Since the current going through this resistor is very small the voltage drop developed across the 100 ohm resistor (R17) is also very small and as a result the triac will not trigger.

In the triggered state the digital circuit has its current supplied via Q2, Q3, and Q4 transistors (MPSA44) Thus bypassing the 33K 2W resistor and replacing it with a virtual short. In effect this increases the current through the Bridge rectifier and in turn the 100 ohm 1W resistor current increases and the voltage dropped across R17 increases to a point where the DIAC becomes active and fires the TRIAC (BT137) (Turns the Light on).

When the triac is in the active state the supply to the digital circuit is produced by rectifying the voltage dropped across the triac (Q7).

Ambient Light Level Detection:

Enables the uses to preset the level or light in which the “Auto” mode will activate tho Light i.e. if the level was set to Low light the room would have to be almost pitch black to allow the light to turn on.

The circuit revolves around the Light Dependent Resistor (LDR). This LDR changes its value of resistance depending on the amount of ambient light present on its surface. The circuit uses two Transistors that have hysterisis (positive feedback) which prevents the light from erratically turning on and off making this setup stable in all light conditions.

Timing Control:

The user may set the time at which the light will remain on via the potentiometer.

The pot (potentiometer) is a variable resistor which is Logarithmic The reason for this is that people will be able to finely adjust the lower on times eg 1 min to 4 min quite accurately (within ±10 sec) but an they approach the high on times (20 to 30 min) the setting becomes coarse because when people are looking at having on times of around 30 min there is no need to be accurate to the ±30 sec.

This Circuit (R29, R35, R28, C18) is mostly controlled by the micro Controller (U2) AT9052313. The RC (Resistor times capacitor) ratio dictates the times for the light to be on. If the resistor is of a low value the time taken to charge the capacitor will be a lot shorter. If the pot was at a higher value of resistance the time to charge the capacitor will be a lot longer. The Micro controller times this time by discharging the capacitor then timing how long it takes to charge back up to a threshold voltage.

Receiver:

This receiver is the RX5000 or TR3000 (U1). The receiver is primarily to receive the RF (Radio Frequency) from the peripheral device such as a WPIR (Wireless passive infrared detector). This receiver is state of the art and for technical specifications and operation consult the Data Sheet supplied by RFM.

Micro Processor:

The Microprocssor used is the ATMEL AT90S2313 RISC (Reduced instruction set) with 128 bytes of RAM (Random Access Memory), 128 bytes EEPROM (Electrically erasable programmable read only memory), 2K flash with a two stage pipeline using Harvard architecture. The micro uses a 1.8432 Mhz crystal to generate its running frequency.

This system is ISP (in circuit programmable) via the IDC6 connector.

The processor mostly looks after the receiver to decode the incoming RF fixed code data which the other peripherals transmit. It also looks after the previously described parts of the circuit to make it an intelligent system.

### SECOND EMBODIMENT

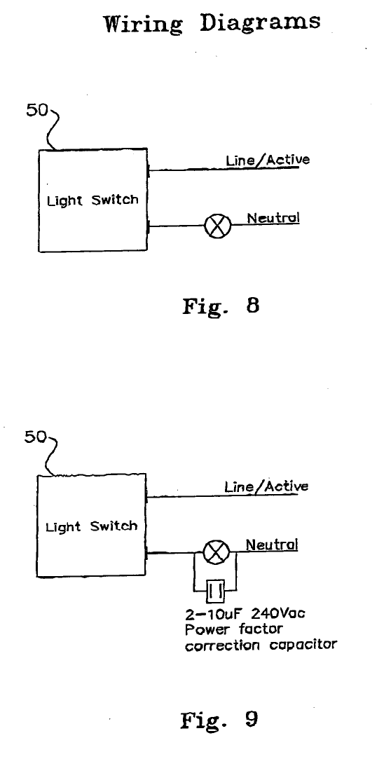

With reference to FIGS. 6, 7, 8, 9 and 10 a description of a remote sensor system 50 in accordance with a second preferred embodiment of the present invention will now be described:

Load and Power Supply:

The load may comprise of a resistive element, Fluorescent, energy saving lights, incandescent or fan.

The load should not exceed 400 VA.

The power supply is designed to run 50 Hz@80 v to 265V.

Wiring:

Install hardware as per standard light switch fitting. The Light switch wired in series with the load as shown in FIG. 6.

Switch Configuration.

The switch will operate as a normal light switch i.e. both “up” (top pushed in)=ON both “down”=off.

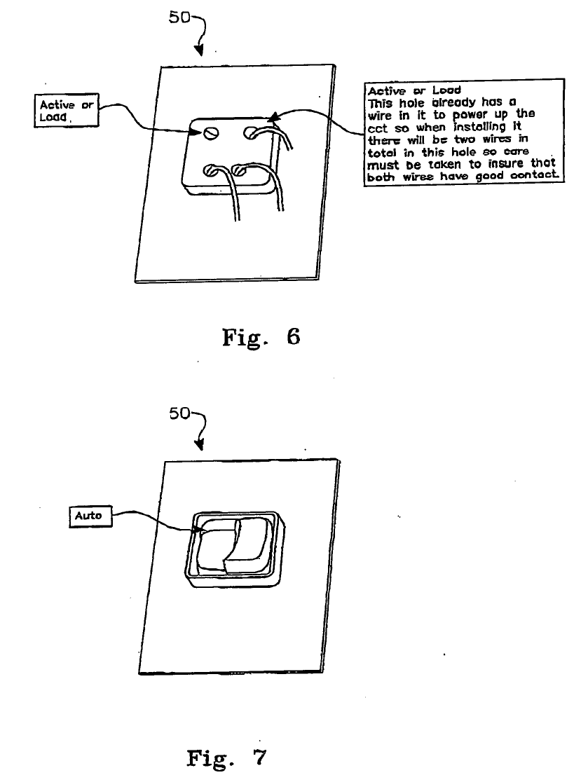

To activate Auto mode: The AUTO switch only in the on position. i.e. opposite to the position shown in FIG. 7.

Light Sensitivity:

A potentiometer is used to adjust the lowest light level at which the light is to activate when in Auto mode. If the potentiometer is full lock left the light will work in daylight and if it is full lock right the light will only work in pitch black.

Timing/On Time Adjustment:

A separate potentiometer controls the time that the light will stay on for in Auto mode. If the potentiometer is fully left the light will be on “3 second test mode” for programming and testing the light switch. Once the potentiometer is rotated clockwise past the start position (full lock left) the time starts at 4 minutes and continues around to 1 hour at full lock right. It may be practical to have the light set longer than needed while using the PIRW (wireless passive infrared detector) as the detector “turns off” for 3 minutes after it has triggered i.e. it will not detect movement for 3 minutes at all.

Operation:

The system 50 can be configured to two modes of operation.

Auto: When Auto is selected the light will automatically turn the load on when the wireless detector device is triggered if the light level detected is at the correct ambient light level to allow the light to turn. The light will turn off when the preset time has being reached since when the device was last triggered. If the load is still active and the wireless device is triggered the load will stay active i.e if the load was a light and someone was in the room triggering the passive infrared detector the light would stay on.

Manual; This would be normal light operation i.e. both up=OFF both down=ON.

Power Supply:

A complete technical explanation of the power supply circuit of FIG. 10 is as follows.

The load may consist of a resistive element, Fluorescent, energy saving lights, incandescent or fan.

The fundamental operation of the power supply is to supply enough power to keep the regulator regulating 2.75V from the 240 v 2-wire system. This is done by rectifying 240 v and using the first 30V of the 240 v supply to supply enough current to the 100 uF cap C16 to keep the rest of the digital circuit operating for the rest of the wave.

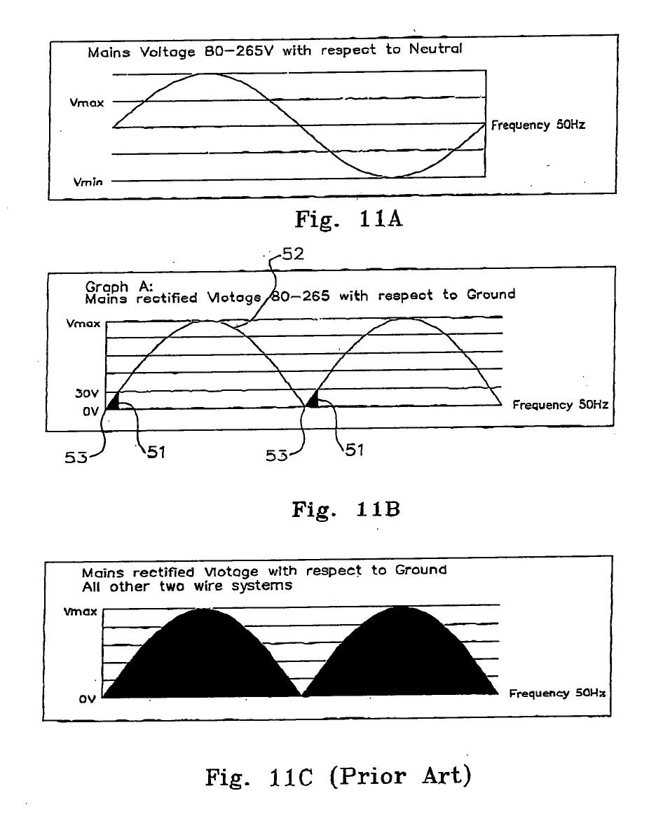

The shaded section on the graph of FIG. 11B indicates the areas where capacitor C16 is being charged therefore the rest of the cycle (not shaded) C16 is NOT being charged. When the triac is not being triggered (load off) Q4 allows current to flow directly into C16 until 30V is reached where Q3 and Q9 force Q4 to turn off the current for C16 during the remaining cycle. When the Triac is triggered (Load ON) Q2 charges C16 directly until the Triac “fires” (turns on) this also stops the capacitor from charging. Using this method relies on C16 retaining enough charge to maintain good regulation to power the rest of the circuit.

The shaded section is a graphical representation of the efficiency of the circuit of the present embodiment. All other two-wire systems are represented on the graph of FIG. 11C and are clearly inefficient.

Light OFF:

When the triac is not fired (light off) the cap C16 has its current supplied via the diode, resistor and FET (ZVN0545) (D7, R38, R39 and Q4 respectively). Since the current through the resistor is very small the voltage drop developed across the 100-ohm resistor (R17) is also very small and as a result the 100 R resistor will not generate enough voltage to turn the silicon bi-directional switch (D4) to the on state which would in turn on the triac. When activating the light automatically via the “TRIGGER” (R19, Q1 and R23) connection to the micro there is a zero crossing detection circuit R7, RS, DS and Q5 to prevent all the inherent problems of switching the load on at high voltage reducing any possible induced noise.

It will be observed, with reference to FIG. 11B, that the zero crossing arrangement above described allows leakage current to be utilised and derived from only predetermined portions 51 of the rectified mains frequency voltage wave form 52. In this particular instance the predetermined portions are close to zero crossings 53 of the rectified wave form 52 as generally illustrated in FIG. 11B.

This arrangement is to be contrasted with prior art arrangements as shown in FIG. 11C wherein leakage current is derived from the entire voltage wave form.

FIG. 11A illustrates the unrectified voltage wave form from which the rectified wave form of FIG. 11B is derived.

Light ON:

In the triggered state the digital circuit has its current supplied via Q2 FET. This shorts out the Q4 circuit to charge the Capacitor C16 to charge it more quickly which in turn draws more current threw the bridge rectifier (BR1) making the voltage dropped across the 100 ohm resistor (R17) great enough to cause the diac (D4) thus turning on the light.

To make this product energy efficient there is a biasing circuit that stops the capacitor getting charged up above 30 Volts reducing the amount of heat dissipated, and therefore power dissipated, making this circuit truly an energy saver. This circuit consists of R40, R41, R42, R21, D5, D1 and Q3. To further increase the efficiency and reliability of the circuit the circuit is D6, R46, R45, C20, Q9 and R43 detects the voltage on the capacitor C16 and switches of the charging circuit to prevent any extra power.

Receiver:

This receiver can be the RX5000 or TR3000 (U1) made by RFM, This device receives all the R1 (ratio frequency) from the peripheral wireless devices.

Microprocessor:

The microprocessor can be an ATMEL AT90S2313 RISC (Reduced instruction set) with 128 Bytes of RAM (Random access memory), 128 bytes of EEPROM, 2K bytes of flash with two stage pipeline with Harvard architecture. This microprocessor uses a 1.8432 Mhz crystal to generate its running frequency which means that this micro can execute 1843200 instruction per second.

The system is in circuit programmable via the IDC6 connector.

The processor's main function is for decoding the receiving of the fixed code from the wireless peripheral devices.

The arrangement thus described with reference to the second preferred embodiment allows reception of a “motion sensed” signal via an RFP radio frequency signal at, for example, 434 MHz relying on AM modulation utilising on/off keying. This arrangement allows transmission of the motion sensed signal in bursts with a maximum power transmission of 25 mW and, more typically 1 mW over ranges up to 400 metres but, more preferably, ranges within a typical room dimension, which is to say ranges to 200 m, more preferably to 50 m and even more preferable down to around 10 m being that of a typical large room arrangement.

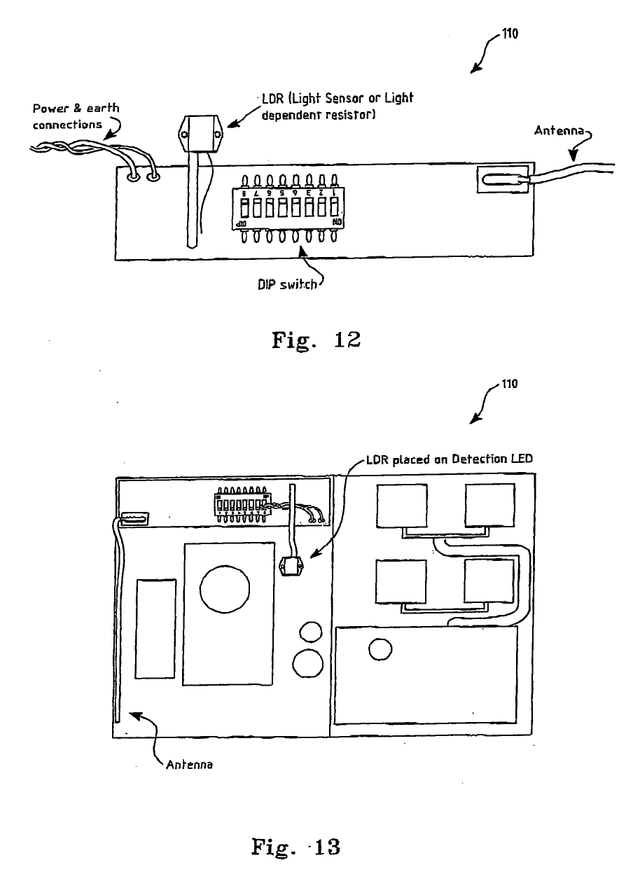

With reference to FIGS. 12, 13 and 14 there is illustrated a pilot transmitter 110 in accordance with a third preferred embodiment of the present invention and which will be now described in further detail:

Technical Construction File

Pilot Light TX

The pilot transmitter 110 is designed to transmit when the light level changes by a set amount. The main application for the pilot transmitter 110 is to convert HPIR (Hard wired passive infrared detectors) to be compatible with the light switch system 50 previously described. Other applications can be to sense when various pilot lights/warning lights come on or off i.e. warning lights on Commercial fridges & freezers, Air conditioner, hard wired smoke sensors, PC power light, server, UPS (Un-interruptable power supply) for vital equipment etc. The pilot transmitter 110 can be programmed into a receiver to that is capable of sending custom SMS warnings for all these applications or other responses from various systems.

Many households and businesses have existing hardwired alarm systems installed into their premises. To take full advantage of these existing HPIR the pilot transmitter 110 can be installed into a HPIR with the pilot transmitter placed inside the case.

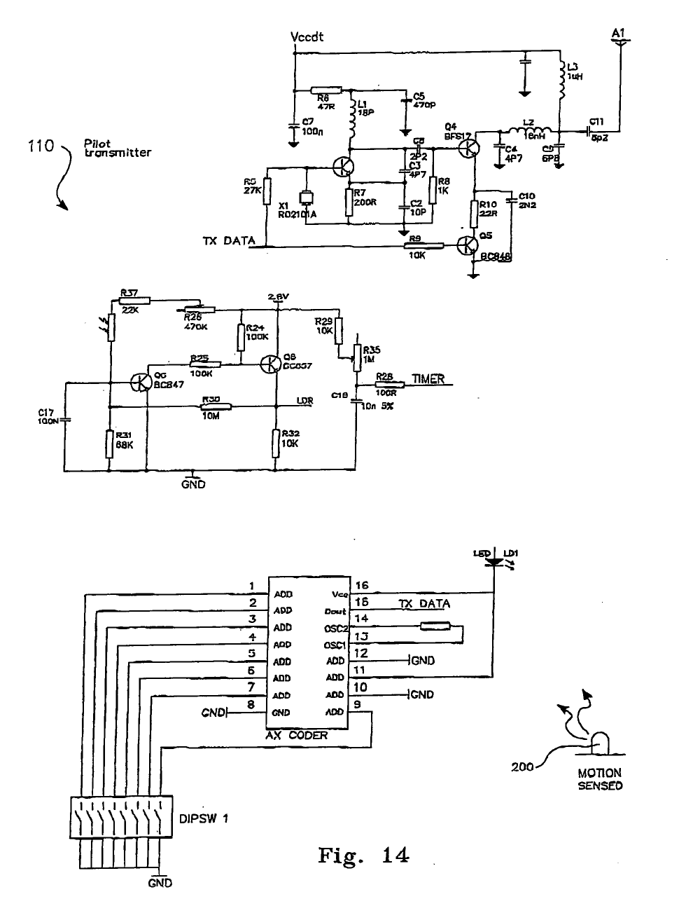

Installation: With reference to FIG. 14:

Red=+12V

Black=0V/Ground

LDR: To be bent into a position where the surface of the LDR is in direct contact with the LED that is activated when the HPIR detects valid movement (be sure that the correct LED is chosen as one LED is a pulse count and the other is a valid detection).

Antenna: Bend the antenna to cover the outside of the PIRW keeping it as far as possible away from the circuit board. Do not cut the antenna.

DIPSWITCH: The dipswitches must be configured into a series of “on” and “off” (up and down) that you would consider to not be common as this will be the code that is transmitted buy the QTX. Once the system is installed and working the device has to be learned into the receiver, that is the receiver 50.

In use the pilot transmitter module 110 as previously described can be retrofitted to an existing motion sensor module and can be wired to derive DC power from the same source that the motion sensor module derives power from. In the above described arrangement the “motion sensed” signal is derived by sensing light emitted from an LED 200 or equivalent light emitting device incorporated within the motion sensor modulo and which is arrangement to emit light when the motion sensor module detects motion within its range. In this way no direct electrical connection needs to be made between the electrical circuit of the pilot transmitter 110 and the electrical circuit of the motion detector. Instead the pilot transmitter 110 transmits a “motion sensed” signal when it detects light from the LED 200 forming part of the motion detector module.

Thus, whilst the pilot transmitter 110 has been described as an integral part of the security alarm wireless energy saving system described earlier in the specification, it may also be utilised in other environments where it is desired to transmit a radio signal which corresponds to either the turning on or turning off of an LED 200 or equivalent in any other device or form of machinery.

The above describes only one embodiment of the present invention and modifications, obvious to those skilled in the art, can be made thereto without departing from the scope and spirit of the present invention.

Industrial Applicability

The above system is applicable to energy conservation arrangements where it is desired to ensure that lights in rooms in domestic houses or industrial establishments or commercial establishments are not left on unnecessarily and, at the same time, utilise already available motion detection systems as already in place for alarm systems and the like. The system can also be applied in reverse to assist in detection of intruders whereby the system turns on lighting to assist, or example, video systems in the event intrusion is detected at night.

1. A security alarm wireless energy saving system that allows for the saving of electrical energy by incorporating a miniature coded UHF radio transmitter into new or existing security alarm detection devices.

2. The system of claim 1 wherein said transmitter communicates with a matching coded UHF receiver.

3. The security alarm wireless energy saving system of claim 1 or claim 2 wherein the transmitter design can be adopted by alarm system manufacturers to be incorporated into the circuitry of their existing or future alarm detection device designs.

4. The security alarm wireless energy saving system of claim 1 or claim 2 wherein the receiver design can be adopted by alarm system or electrical appliance manufacturers to be incorporated into the circuitry of their existing or future products.

5. An alarm detection device incorporating a radio transmitter for transmission of a predetermined condition of said alarm detection device.

6. The alarm detection device of claim 5 wherein said alarm detection device comprises a movement detector for a room and said predetermined condition in the condition of detection of movement in said room by said movement detector.

7. The alarm detection device of claim 5 or claim 6 wherein said radio transmitter is integral to said alarm detection device.

8. The alarm detection device of claim 5 or claim 6 wherein said radio transmitter is adapted to be retrofitted to said alarm detection device.

9. The alarm detection device of any one of claims 5 to 8 powered by a battery.

10. The alarm detection device of any one of claims 5 to 9 wherein said radio transmitter is adapted for communication with a receiver mounted in a light switch.

11. The alarm detection device of claim 10 wherein said light switch includes a receiver means and switch means for selectively interrupting power to a room light mounted in said room.

12. The alarm detection device of claim 11 wherein said switch means is integral to said light switch.

13. The alarm detection device of claim 10 wherein said receiver and switch means is adapted to be retrofitted to said switch.

14. The alarm detection device of claim 10, 11 or 12 wherein said receiver and switch means is powered by the same power supply which powers said light.

15. The alarm detection device of claim 10, 11 or 12 wherein said receiver and switch means is powered by leakage current from said light circuit.

16. The alarm detection device of any previous claim in communication with said existing security alarm detection device.

17. A switch module for retrofitting to a light switch; said switch module incorporating receiver means and switch means; said receiver means adapted to receive a signal from the radio transmitter of an alarm detection device according to any one of claims 5 to 15.

18. The switch module of claim 16 wherein said switch means is adapted to interrupt power supply between said switch module and an appliance powered by said switch module.

19. A transmission module for retrofitting to an alarm detection device; said transmission module including a radio transmitter for transmission of a predetermined condition of said alarm detection device.

20. The alarm detection device of any one of claims 5 to 15 wherein said device comprises a movement sensor.

21. The alarm detection device of any one of claims 5 to 15 wherein said alarm detection device comprises a trip switch or door or window position switch.

22. A security alarm wireless energy saving system including at least one alarm detection device in combination with at least one integral switch receiver; said system allowing for the saving of electrical energy by incorporating a miniature coded UHF radio transmitter into a new or existing security alarm (sensor) detection device; and wherein said radio transmitter is adapted inside the sensor for communication with said integral receiver switch; and wherein said receiver switch incorporates the means for selectively interrupting power to a room light mounted in the same room as at least one alarm detection device; and wherein said switch means is integral to said light switch; and wherein said receiver and switch means is powered by series current load.

23. A pilot transmitter system for transmission of RF radio signals to a light-switch based receiver mounted at close range.

24. The transmitter of claim 23 wherein information is transmitted in bursts only.

25. The sensor of claim 23 or claim 24 wherein range is between 1 m and 400 m.

26. The sensor of claim 25 wherein the range is between 1 m and 200 m.

27. The sensor of claim 26 wherein the range is between 1 m and 50 m.

28. The sensor of claim 27 wherein the range is within a single room.

29. A system for deriving leakage current from a two wire system, said system comprising utilising only predetermined portions of said leakage current.

30. The system of claim 29 wherein said leakage current takes a sinusoidal wave form and said predetermined energy comprises a portion of energy at or close to zero crossings of said wave form.

31. A method for minimising lighting energy usage in conjunction with the operation of an alarm motion detector; said method comprising:
(a) installing wireless activated switching means as or as a substitute for an existing light switch for a room;
(b) installing or activating a motion detector transmitter located in an alarm motion detector mounted in said room;
whereby said transmitter can transmit to said wireless activated switching means a “motion sensed” signal; said “motion sensed” signal causing said wireless activated switching means to supply power to a light in said room.

32. The method of claim 31 wherein said wireless activated switching means includes daylight sensing means whereby power is supplied to said light when daylight is not sensed.

33. The method of claim 31 or claim 32 wherein said alarm motion detector is also in communication with an alarm system whereby a “motion sensed” signal is also communicated via said motion detector transmitter to an alarm system located independently of said light switch.

34. The method of claim 31 or claim 32 or claim 33 wherein said alarm motion detector is located so as to function as a motion detector for detection of motion occurring anywhere in said room.

35. A system for minimising lighting energy usage for use in conjunction with an alarm system comprising installing wireless activated switching means as a substitute for an existing light switch in a room: installing or activating a motion detector transmitter located in an alarm motion detector mounted in said room; said alarm motion detector utilised for transmitting a “motion sensed” signal both to said wireless activated switching means and also to an alarm system.
